(19) United States
(12) Patent Application Publication
(10) Pub. No.: US 2016/0282581 A1
(43) Pub. Date: Sep. 29, 2016

(54) Modular Autofocus System

(71) Applicant: O-Sip Co., Ltd., Zhudong Township (TW)

(72) Inventor: Cheng-Yu Huang, Zhudong Township (TW)

(21) Appl. No.: 15/080,633

(22) Filed: Mar. 25, 2016

(30) Foreign Application Priority Data
Mar. 27, 2015 (TW) 104204640

(51) Int. Cl. G02B 7/08

(52) U.S. Cl. CPC G02B 7/08

(57) ABSTRACT

A modular autofocus system having the characteristics of simple manufacturing process and high yield is disclosed to include a package member having a lightpath cut through opposing top and bottom sides thereof, coils packaged in the package member around the lightpath using the IC packaging technology, and a driver packaged in the package member using the IC packaging technology and electrically coupled with the coils.

### BACKGROUND OF THE INVENTION

1. Field of the Invention

The present invention relates to focusing technology, and more particularly to a modular autofocus system capable of automatically driving a lens assembly to perform focusing or zooming.

2. Description of the Related Art

A mobile electronic device such as digital camera or mobile communication device general has a lens module built therein. A lens module for this purpose generally comprises an image sensor, a lens assembly, and a voice coil motor. The voice coil motor is controllable to move the lens assembly away or toward the image sensor, achieving autofocus or zoom. At present, the voice coils of a voice coil motor are mounted in a hollow lens holder that is covered with a cap to protect the voice coils. This voice coil mounting arrangement has drawbacks as follows:

(1) The image sensor, the voice coils and the lens assembly must be separately and electrically connected to the control circuit and then assembled together, complicating the installation process; the current method is to electrically connect the voice coils and the lens assembly to the control circuit with bus lines, leading to complicated fabrication process and low yield.

(2) Using a lens holder and a cap to keep a void coil motor in position needs to bond the lens holder and the cap together using a laser bonding or spot gluing technique, complicating the fabrication process, creating barriers in miniaturization of digital cameras and mobile communication devices, and thus, this prior are design is not conducive to development of digital cameras and mobile communication devices having light, thin, short and small characteristics.

Therefore, how to solve the problems and drawbacks of the above-described prior art designs is an issue of concern to people in the related industries.

### SUMMARY OF THE INVENTION

The present invention has been accomplished under the circumstances in view. It is the main object of the present invention to provide a modular autofocus system, which has the driver and the coils be packaged in a package member using the integrated circuit packaging technology and the coils be electrically connected to the driver, simplifying the fabrication and improving the yield, and thus, when the modular autofocus system is used in a digital camera or mobile communication device, the digital camera or mobile communication device can control the coils via the driver.

Thus, the invention simplifies the arrangement of the component parts of the digital camera or mobile communication device, and facilitates the designer of the digital camera or mobile communication device to use the modular autofocus system.

It is another object of the present invention to provide a modular autofocus system, which has conductive contacts at the package member thereof be electrically connected to the image sensor so that the digital camera or mobile communication device can directly control the coils and the image sensor after electric connection between the modular autofocus system and the circuit board of digital camera or mobile communication device, facilitating the designer of the digital camera or mobile communication device to use the modular autofocus system.

To achieve these and other objects of the present invention, a modular autofocus system comprises a package member, a plurality of coils and a driver. The coils and the driver are packaged in the package member using the IC packaging technology, wherein the coils are respectively electrically connected to the driver; the package member comprises a lightpath cut through opposing top and bottom sides thereof; the coils are spaced around the lightpath.

Preferably, the package member comprises a first package component and a second package component respectively located at the opposing top and bottom sides thereof. The lightpath defines a first accommodation space in the first package component, and a second accommodation space in the second package component. The inner diameter of the second accommodation space is larger than the inner diameter of the first accommodation space. The package member comprises a bearing surface defined in the lightpath, and a plurality of first conductive contacts located at the bearing surface and electrically connected to the driver. The modular autofocus system further comprises a filter mounted in the first accommodation space, and an image sensor mounted in the second accommodation space. The image sensor is electrically connected with the first conductive contacts.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic perspective view of a modular autofocus system in accordance with the present invention.

FIG. 2 is an oblique bottom elevational view of the modular autofocus system in accordance with the present invention.

FIG. 3 is a schematic top plain view of the modular autofocus system in accordance with the present invention.

FIG. 4 is a schematic sectional view of the modular autofocus system in accordance with the present invention.

FIG. 5 is an oblique top elevational view of one coil for the modular autofocus system in accordance with the present invention.

FIG. 6 is a schematic drawing illustrating the packaging of the coils in the first package component in accordance with the present invention (I).

FIG. 7 is a schematic drawing illustrating the packaging of the coils in the first package component in accordance with the present invention (II).

FIG. 8 is a schematic drawing illustrating the packaging of the coils in the first package component in accordance with the present invention (III).

FIG. 9 is a schematic drawing illustrating the packaging of the coils in the first package component in accordance with the present invention (IV).

FIG. 10 is a schematic sectional view illustrating the modular autofocus of the present invention assembled with a lens assembly.

FIG. 11 is a schematic top plain view illustrating an alternate form of coils installed in the modular autofocus system.

### DETAILED DESCRIPTION OF THE INVENTION

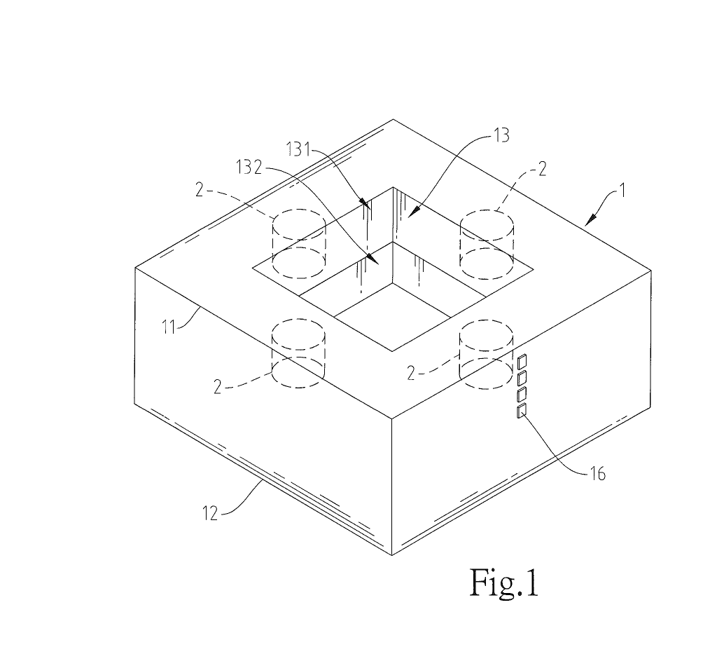

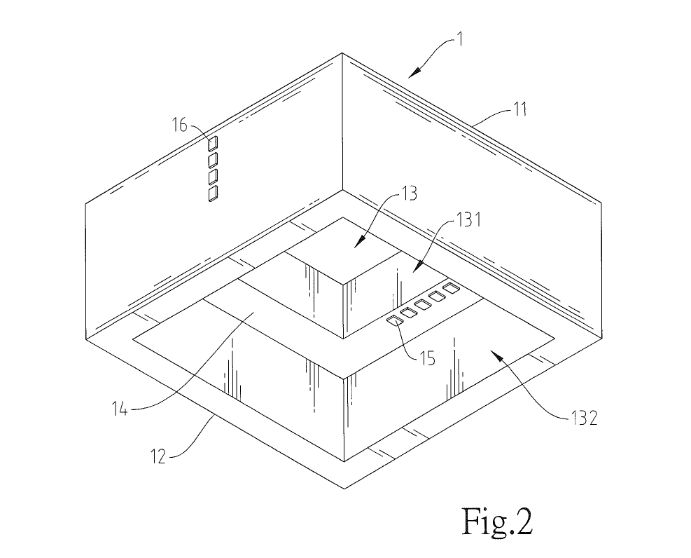

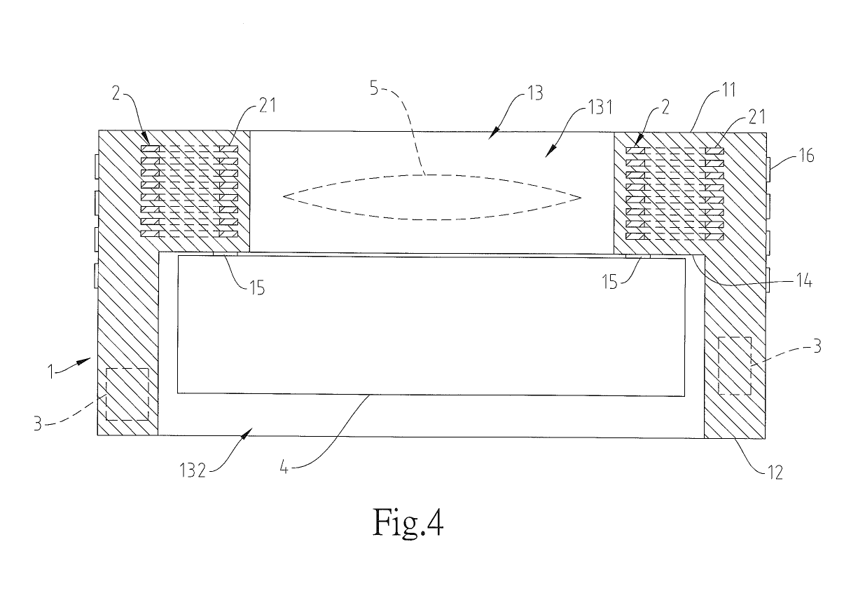

Referring to FIGS. 1-5, a modular autofocus system in accordance with the present invention is shown. As illustrated, the modular autofocus system comprises a package member 1, a plurality of coils 2, a driver 3, an image sensor 4, and a filter 5.

The package member 1 comprises a first package component 11 and a second package component 12 respectively located at opposing top and bottom sides thereof, a lightpath 13 cut through the opposing top and bottom sides and forming a first accommodation space 131 of a relatively smaller diameter in the first package component 11 and a second accommodation space 132 of a relatively larger diameter in the second package component 12, a bearing surface 14 defined in the lightpath 13 between the first accommodation space 131 and the second accommodation space 132, a set of first conductive contacts 15 located at the bearing surface 14, and a set of second conductive contacts 16 located at an outer surface thereof.

Further, the package member 1 is made using the integrated circuit packaging technology, having the coils 2 and the driver 3 embedded therein. When making the second package component 12, the driver 3 is packaged in the second package component 12. When making the first package component 11, the coils 2 are packaged in the first package component 11 and spaced around the lightpath 13. Further, the coils 2 are electrically connected to the driver 3; the first conductive contacts 15 and the second conductive contacts 16 are respectively electrically connected to the driver 3. The image sensor 4 is mounted in the second accommodation space 132 and electrically coupled with the first conductive contacts 15. The filter 5 is mounted in the first accommodation space 131. Further, the filter 5 is this embodiment is a blue filter glass.

Further, each coil 2 comprises a plurality of conductive strips 21 stacked up on one another, and a plurality of conductive spacer blocks 22 respectively connected between each two adjacent conductive strips 21. The conductive strips 21 are shaped like a split ring, each having an input end 212, an opposing output end 213 and a circumferential gap 211 defined between the input end 212 and the output end 213. Each conductive spacer block 22 has one end thereof electrically connected to the input end 212 of the adjacent top-sided conductive strip 21, and an opposing end thereof electrically connected to the output end 213 of the adjacent bottom-sided conductive strip 21. Thus, the conductive strips 21 are connected in series by the conductive spacer blocks 22. Further, the output end 213 of the topmost conductive strip 21 of each coil 2 and the input end 212 of the lowest conductive strip 21 are respectively electrically connected to the driver 3.

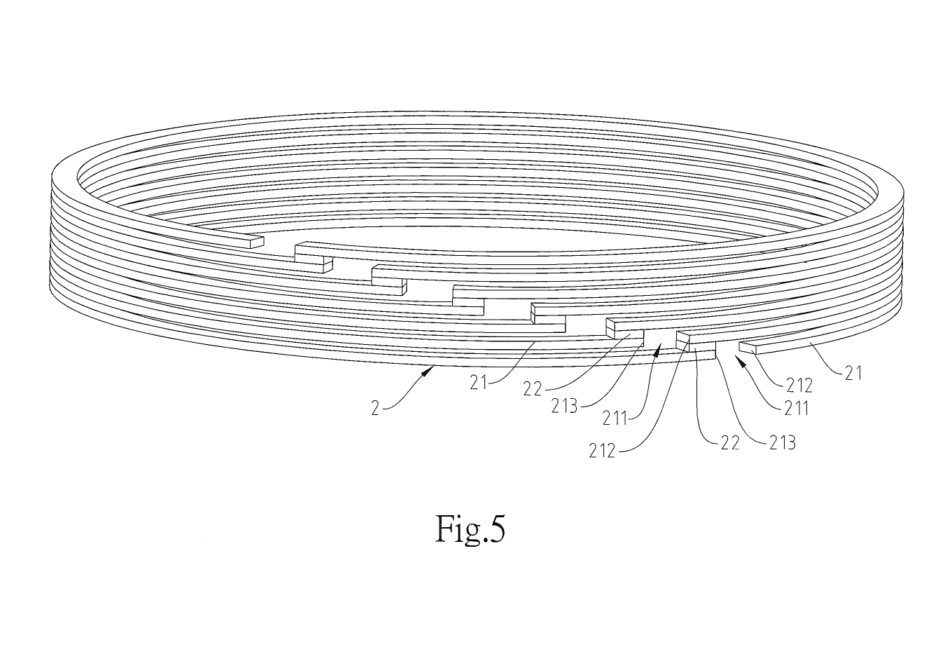

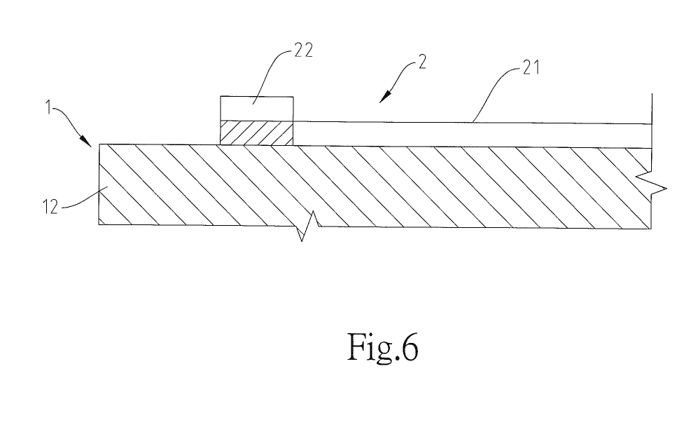

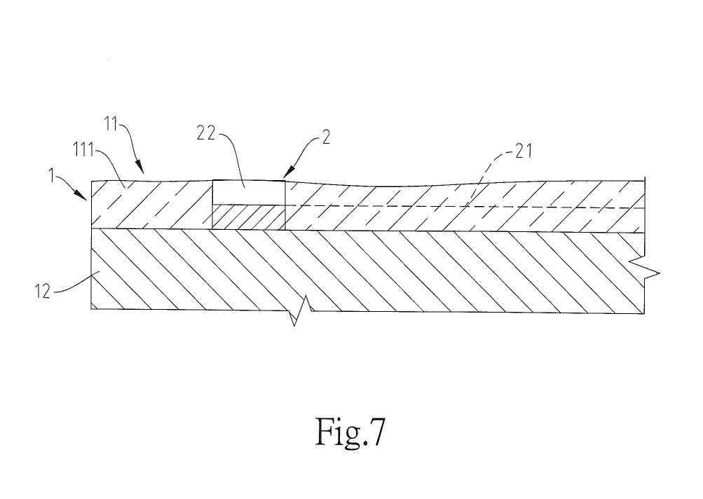

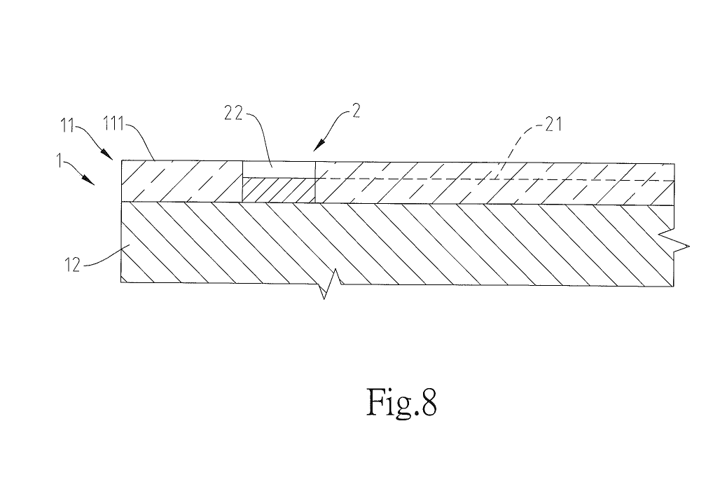

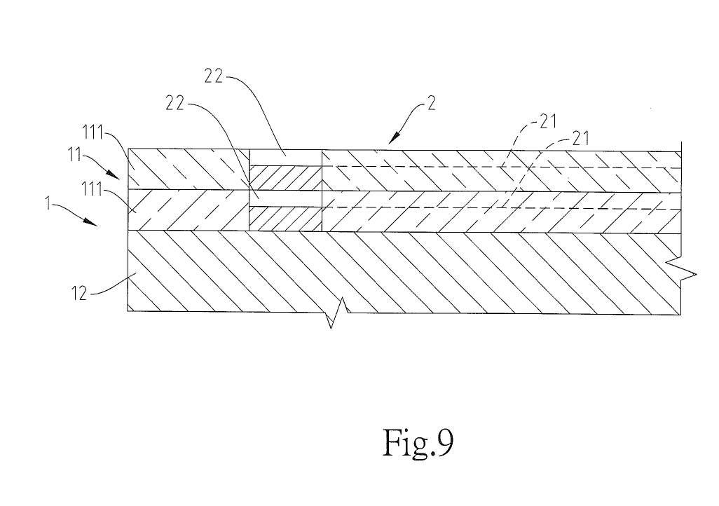

Referring to FIGS. 5-9, the coils 2 are packaged in the first package component 11. When packaging the coils 2, as illustrated in FIG. 6, position one conductive strip 21 on the surface of the second package component 12, and then electrically connect one end of one conductive spacer block 22 to the output end 213 of the conductive strip 21. The conductive spacer block 22 can be bonded to the conductive strip 21, or directly formed on the surface of the conductive strip 21 by sputter deposition or physical vapor deposition. Thereafter, as shown in FIG. 7, cover an encapsulation adhesive layer 111 over the installed conductive strip 21 and conductive spacer block 22. As illustrated in FIG. 8, after covered the encapsulation adhesive layer 111 over the installed conductive strip 21 and conductive spacer block 22, the surface of the coated encapsulation adhesive layer 111 does not complete flat. At this time, a surface processing step (for example, grinding) is necessary to level the surface of the encapsulation adhesive layer 111, enabling the surface of the conductive spacer block 22 to be exposed to the outside of the encapsulation adhesive layer 111 in a flush manner. Thereafter, as shown in FIG. 9, position another conductive strip 21 on the surface of the coated encapsulation adhesive layer 111, and then electrically connect one end of another conductive spacer block 22 to the output end 213 of the conductive strip 21 the coated encapsulation adhesive layer 111, and then cover another encapsulation adhesive layer 111 over this newly installed conductive strip 21 and conductive spacer block 22 and the previously coated encapsulation adhesive layer 111, keeping the input end 212 of this newly installed conductive strip 21 electrically connected to the conductive spacer block 22 in the previously coated encapsulation adhesive layer 111. By means of repeating the aforesaid procedure, the coils 2 are packaged in the first package component 11. Briefly speaking, the first package component 11 is composed of multiple encapsulation adhesive layers 111; each encapsulation adhesive layer 111 has embedded therein a conductive strip 21 and a conductive spacer block 22; each conductive spacer block 22 has its one end electrically connected to the output end 213 of one respective conductive strip 21 and its other end exposed to the outside of the associating encapsulation adhesive layer 111; each conductive strip 21 has its bottom surface exposed to the outside of the associating encapsulation adhesive layer 111; by means of electrically connecting the input end 212 of the conductive strip 21 in one upper encapsulation adhesive layer 111 to the conductive spacer block 22 in the adjacent lower encapsulation adhesive layer 111, the conductive strips 21 of each coil 2 are electrically connected in series.

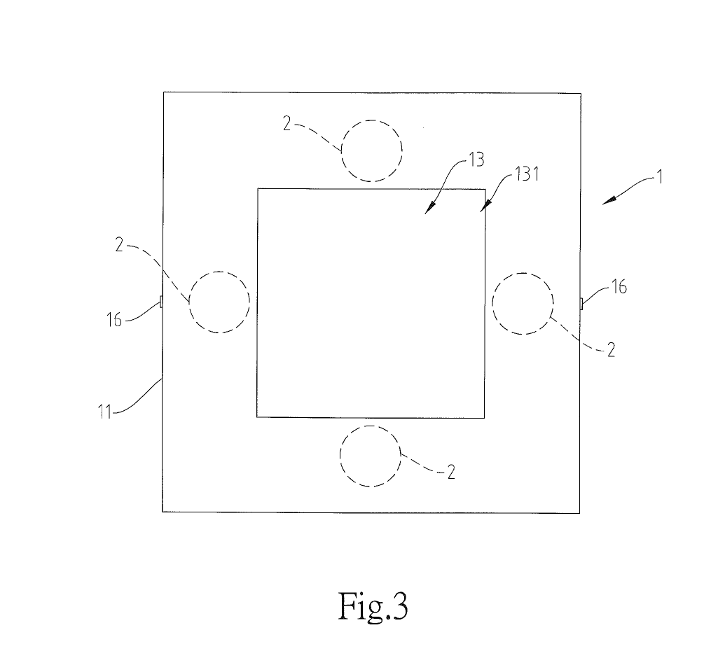

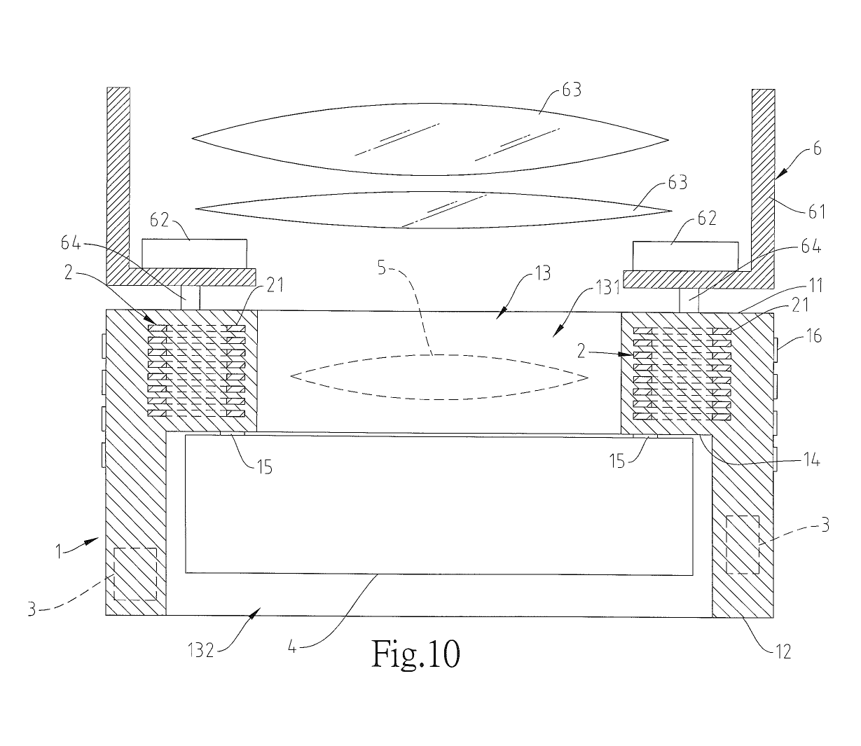

Referring to FIG. 1, FIG. 3 and FIG. 10, when using the modular autofocus system, place a lens assembly 6 on the top side of the first package component 11 of the package member 1. The lens assembly 6 comprises a lens holder 61, permanent magnets 62 located at a top surface of a bottom wall of the lens holder 61 corresponding to the coils 2, lenses 63 arranged in the lens holder 61, and an elastic suspension cradle 64 located at an outer surface of the bottom wall of the lens holder 61 and connected to the first package component 11.

Thus, the digital camera or mobile communication device carrying the aforesaid lens assembly 6 can be electrically connected with the driver 3 through the second conductive contacts 16. After installation of the modular autofocus system in the digital camera or mobile communication device, the shake sensor of the digital camera or mobile communication device such as gyro sensor or accelerometer can detect hand shaking, and then drive the driver 3 to control the coils 2 in creating magnetic attraction between the coils 2 and the permanent magnet 62 according to the detection result, causing the lens holder 61 to be biased with the permanent magnet 62 in the X-axis or Y-axis to achieve focusing. Further, the digital camera or mobile communication device can also drive the image sensor 4 to pick up images via the driver 3. If the modular autofocus system is to be used in the digital camera or mobile communication device without shake sensor, the modular autofocus system can be configured to provide a shake sensor and to have the shake sensor be packaged in the package member 1 and electrically connected to the driver 3, enabling the digital camera or mobile communication device to detect hand shaking. With respect to how the coils 2 control the displacement of the lens assembly 6 to achieve autofocus or zooming, the technique is of the known art and not within the scope of the claims of the present invention, and therefore, no further detailed description in this regard will be necessary.

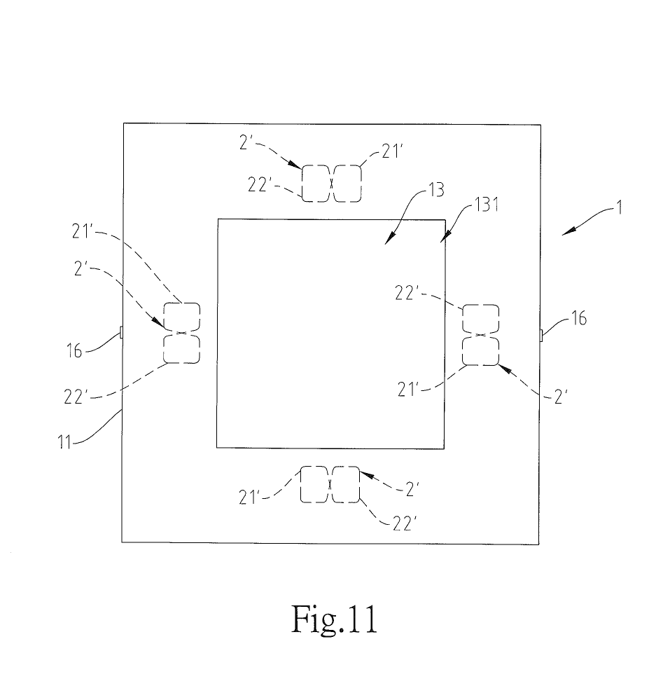

Referring to FIG. 5, FIG. 10 and FIG. 11, in an alternate form of the present invention, as illustrated in FIG. 1, each coil 2′ has an 8-shaped cross section. When compared with the coils 2 shown in FIG. 5, the coils 2′ each comprise a first half 21′ and a second half 22′; by means of magnetic induction between the first halve 21′ and second halve 22″ of the coils 2 and the permanent magnet 62, the lens holder 61 can be tilted accurately in the X-axis or Y-axis.

Thus, the technical features of the invention that solve the problems and drawbacks of the prior art designs are as follows:

(1) The invention has the coils 2 and the driver 3 be packaged in the package member 1 to form a modular autofocus system, thus, after installation of the modular autofocus system in a digital camera or mobile communication device, the digital camera or mobile communication device can control the coils 2 via the driver 3, simplifying the arrangement of the digital camera or mobile communication device.

(2) The invention has the coils 2 be packaged in the package member 1 using the IC packaging technology, simplifying the installation of the coils 2, improving the product yield, facilitating miniaturization of the size of the coils 2, and enabling the number of turns of the coils 2 to be maximized to enhance the magnetic field.

(3) The invention has the first conductive contacts 15 at the package member 1 be electrically connected to the image sensor 4, enabling the digital camera or mobile communication device that uses the modular autofocus system to control the coils 2 and the image sensor 4 via the driver 3 in the package member 1, facilitating the designer of the digital camera or mobile communication device to use the modular autofocus system.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A modular autofocus system, comprising:
a package member comprising a lightpath cut through opposing top and bottom sides thereof;
a plurality of coils packaged in said package member around said lightpath using the integrated circuit packaging technology; and
a driver packaged in said package member using the integrated circuit packaging technology and electrically coupled with said coils.

2. The modular autofocus system as claimed in claim 1, wherein said package member comprises a first package component and a second package component respectively located at the opposing top and bottom sides thereof; a bearing surface defined in said lightpath, and a plurality of first conductive contacts located at said bearing surface and electrically connected to said driver; said lightpath defines a first accommodation space in said first package component and a second accommodation space in second package component, the inner diameter of said second accommodation space being larger than the inner diameter of said first accommodation space; the modular autofocus system further comprises an image sensor mounted in said second accommodation space and electrically connected to said first conductive contacts.

3. The modular autofocus system as claimed in claim 1, wherein said package member comprises a first package component and a second package component respectively located at the opposing top and bottom sides thereof; said lightpath defines a first accommodation space in said first package component and a second accommodation space in second package component, the inner diameter of said second accommodation space being larger than the inner diameter of said first accommodation space; the modular autofocus system further comprises a filter mounted in said first accommodation space.

4. The modular autofocus system as claimed in claim 1, further comprising a plurality of second conductive contacts mounted at a surface of said package member and electrically coupled with said driver.

5. The modular autofocus system as claimed in claim 1, wherein said package member comprises a first package component and a second package component respectively located at the opposing top and bottom sides thereof, said first package component being formed of a stack of encapsulation adhesive layers; each said coil comprises a plurality of conductive strips and a plurality of conductive spacer block, said conductive strips being shaped like a split ring, each said coil comprising an input end, an opposing output end and a circumferential gap defined between said input end and said output end, each said conductive strip being packaged with one respective said conductive spacer block in one respective said encapsulation adhesive layer, each said conductive spacer block having one end thereof electrically connected to the output end of one respective said conductive strip and an opposite end thereof exposed to the outside of the associating said encapsulation adhesive layer, each said conductive strip having a bottom surface thereof exposed to the outside of a bottom surface of the associating said encapsulation adhesive layer, so that the conductive strips of each said coil are electrically connected in series by means of electrically connecting the input end of the said conductive strip in one upper said encapsulation adhesive layer to the said conductive spacer block in the adjacent lower said encapsulation adhesive layer.
